(19) United States
(12) Patent Application Publication
(10) Pub. No.: US 2012/0143656 A1
(43) Pub. Date: Jun. 7, 2012

(54) GROUP AGGREGATION LEVERAGING SYSTEM

(75) Inventor: Brendan Murphy, Costa Mesa, CA (US)

(73) Assignee: TRIP ALERTZ, INC., Lake Orion, MI (US)

(21) Appl. No.: 13/149,800

(22) Filed: May 31, 2011

Related U.S. Application Data
(60) Provisional application No. 61/349,414, filed on May 28, 2010.

(51) Int. Cl. G06Q 30/02

(52) U.S. Cl. 705/14.1

(57) ABSTRACT

Embodiments of the invention are directed to group aggregation leveraging methods and systems for consumers to buy products from a broker. The broker offers a product to consumers for a first fixed price for a predetermined time period. Once a predetermined number of consumers commit to purchasing the product (i.e., reach a threshold), the consumers receive the same product at a second fixed price wherein the second fixed price is less than the first fixed price. Once the threshold is met, each committed consumer receives an alert from the broker that the consumer will receive the same product at the new reduced price (second fixed price). This process is repeated until the predetermined time period expires or inventory of the product is depleted. Consumers may leverage their collective group buying power by communicating to others that the product is available for the predetermined time period through social media or any other suitable means.

### CLAIM OF PRIORITY UNDER 35 U.S.C. §119

The present application for patent claims priority to U.S. Provisional Application No. 61/349,414 entitled “Group Aggregation Leveraging System”, filed May 28, 2010, and hereby expressly incorporated by reference herein. It should be noted that May 28, 2011 is a Saturday; Monday May 30, 2011 is a federal holiday, Memorial Day, so this application is being filed on the next business day, May 31, 2011.

### FIELD OF INVENTION

At least one feature pertains to a system and method for facilitating the aggregation of unrelated consumer purchase commitments for a featured product using real-time tiered pricing thresholds.

### BACKGROUND OF INVENTION

Tourism is travel for leisure or business purposes. The World Tourism Organization defines tourists as people who “travel to and stay in places outside their usual environment for more than twenty-four (24) hours and not more than one consecutive year for leisure, business and other purposes not related to the exercise of an activity remunerated from within the place visited.” Tourism has become a popular global leisure activity. For example, in 2008, there were over 922 million international tourist arrivals.

Before the advent of the Internet, travel arrangements were usually coordinated and booked by travel agents specializing in the travel/tourism industry. Travel agents were able to access airline reservation systems and had direct connections with hotel operators, cruise line operators and other travel/tourism industry operators, owners and managers. The public generally was not privy to these resources and therefore often relied on travel agents for its travel needs.

The advent of the Internet offered the general public unprecedented access to travel industry resources. Internet-based companies such as Orbitz®, Travelocity®, Priceline® and Expedia® empowered consumers to coordinate and book custom travel packages by providing listings of airline flights, hotels, car rentals and cruises with time, date, pricing and availability information. Although a new industry of e-commerce travel was made possible by the Internet, advertising strategies generally remained traditional. For example, “splash banner advertising” on websites, which is generally the equivalent of traditional print advertising in print magazines, newspapers and other publications, became the norm. As consumers today are constantly utilizing social media (i.e. web-based and mobile technologies to turn communication into interactive dialogue) to communicate with others, consumers want to be engaged and not simply advertised to. As a result, the “splash banner advertising” on websites has been less successful than originally anticipated as consumers are merely being bombarded with advertisements and are not being engaged.

Consequently, a system and method of advertising that engages consumers by leveraging social media is needed.

### SUMMARY

One feature is directed to a method for facilitating the aggregation of unrelated consumer purchase commitments for a product using real-time tiered pricing thresholds. The method includes offering the product to consumers for a first fixed price for a predetermined time period; and offering the product to the consumers for a second fixed price after a first predetermined number of consumers commit to purchase the product at the first fixed price and the predetermined time period has not expired, the second fixed price is less than the first fixed price. After the first number of consumers have committed to purchase the product at the first fixed price, an alert is sent to each committed consumer notifying each of the committed consumers that that the cost of the product has decreased from the first fixed price to the second fixed price.

Furthermore, the product is offered to the consumers for a third fixed price after a second predetermined number of consumers commit to purchase the product at the second fixed price and the predetermined time period has not expired, the third fixed price is less than the second fixed price. Once the second predetermined number of consumers have committed to purchase the product, a new alert is sent to all the committed consumers that the cost of the product has decreased from the second fixed price to the third fixed price.

According to another feature, a broker module for facilitating the aggregation of unrelated consumer purchase commitments for a featured product using real-time tiered pricing thresholds is provided. The broker module may include a memory device; a network interface for communicating over a wireless network; a processing circuit coupled between the memory device and the network interface. The processing circuit is adapted to offer the product to consumers for a first fixed price for a predetermined time period; and offer the product to the consumers for a second fixed price after a first predetermined number of consumers commit to purchase the product at the first fixed price and the predetermined time period has not expired, the second fixed price is less than the first fixed price.

The processing circuit is further adapted to send an alert to each committed consumer that a cost of the product has decreased from the first fixed price to the second fixed price after receiving the first predetermined number of consumer commitments to purchase the product at the first fixed price and offer the product to the consumers for a third fixed price after a second predetermined number of consumers commit to purchase the product at the second fixed price and the predetermined time period has not expired, the third fixed price is less than the second fixed price. The processing circuit is yet further adapted to send an alert to each committed consumer that a cost of the product has decreased from the second fixed price to the third fixed price after receiving the second predetermined number of consumer commitments to purchase the product at the second fixed price.

Another feature provides a computer readable medium having one or more instructions operational on a broker module for facilitating the aggregation of unrelated consumer purchase commitments for a featured product using real-time tiered pricing thresholds. When executed by a processor, the instructions may cause the processor to offer the product to consumers for a first fixed price for a predetermined time period; and offer the product to the consumers for a second fixed price after a first predetermined number of consumers commit to purchase the product at the first fixed price and the predetermined time period has not expired, the second fixed price is less than the first fixed price.

The instructions may further cause the processor to send an alert to each committed consumer that a cost of the product has decreased from the first fixed price to the second fixed price after receiving the first predetermined number of consumer commitments to purchase the product at the first fixed price and offer the product to the consumers for a third fixed price after a second predetermined number of consumers commit to purchase the product at the second fixed price and the predetermined time period has not expired, the third fixed price is less than the second fixed price.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 is a block diagram illustrating the internal functional architecture of a computer system.

FIG. 2 is a block diagram illustrating a general overview of a group aggregation leveraging system according to an embodiment of the present invention.

FIG. 3 illustrates a diagram of an e-commerce group aggregation leveraging system according to an embodiment of the invention.

FIG. 4 is a block diagram illustrating an example of a broker module configured to offer limited time deals having real-time tiered pricing thresholds on products to consumers.

FIG. 5 (comprising FIGS. 5A and 5B) is a flow diagram illustrating a method operational in a broker module for offering limited time deals having real-time tiered pricing thresholds on products to consumers.

FIG. 6 illustrates an example of a screen on a website-based e-commerce site for facilitating the aggregation of unrelated consumer purchase commitments for a featured product using real-time tiered pricing thresholds

### DETAILED DESCRIPTION

The following detailed description is of the best currently contemplated modes of carrying out the invention. The description is not to be taken in a limiting sense, but is made merely for the purpose of illustrating the general principles of the invention.

In the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures and techniques may be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

In the following description, certain terminology is used to describe certain features of one or more embodiments of the invention. The terms “computer system” and “computing device” refer to a desktop device, a mobile device, a wireless device, a mobile phone, a mobile communication device, a user communication device, personal digital assistant, mobile palm-held computer, a laptop computer and/or any general purpose computer system. The term “mobile device” refers to smart phones, mobile phones, pagers, personal digital assistants, and/or personal information managers (PIMs) which communicate, at least partially, through a wireless or cellular network. The term “consumer” refers to any recipient in a business transaction including, but not limited to an individual, groups of individuals, organizations, businesses, Governments, etc. that purchases or makes a decision to purchase a product or is contemplating the purchase of a product. The term “seller” refers to any entity in a business transaction that is exchanging or selling items of value, such as information, goods and services. The term “product” refers to any goods or services that are intended for a user. The term “broker” refers to any individual, groups of individuals, organizations, businesses, Governments, etc. that acts as an agent for itself or others in selling products.

Embodiments of the invention are directed to group aggregation leveraging methods and systems for consumers to buy products from a broker. The broker may be selling products on behalf of other sellers. In one embodiment, the broker offers a product to consumers for a first fixed price for a predetermined time period. The predetermined time period may be a fixed amount of time as determined by the broker or seller. The predetermined time period may be different for each product that is offered for sale. Once a predetermined number of consumers commit to purchasing the product (i.e., reach a threshold), the consumers receive the same product at a second fixed price wherein the second fixed price is less than the first fixed price. The predetermined number may be determined by the seller or broker. The predetermined number may be different for each product that is offered for sale.

Once the threshold is met, each committed consumer may receive a communication or alert from the broker that the consumer will receive the same product at the new reduced price (second fixed price). This process is repeated until one of the following happens: (i) the predetermined time period expires; or (ii) inventory of the product is depleted. Consumers may leverage their collective group buying power by communicating to others that the product is available for the predetermined time period through social media or any other suitable means. The result is that the consumer receives the product at a discounted price by aggregating their group buying power by participating in the purchase, by encouraging others to participate in the purchase, or by a combination of both. In one embodiment, the platform for the system is embodied in an electronic commerce (“e-commerce”) website.

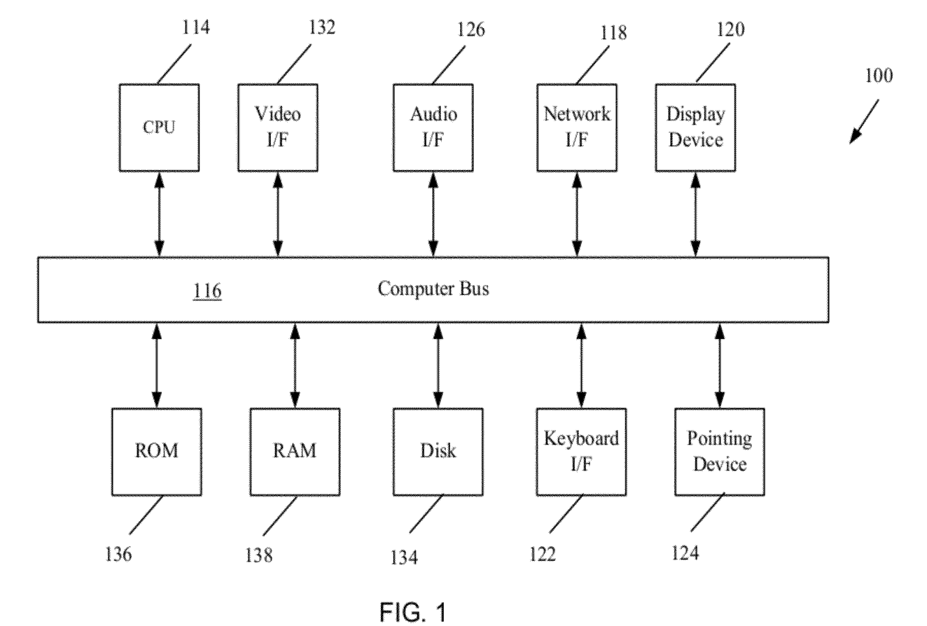

FIG. 1 is a block diagram illustrating the internal functional architecture of a computer system 100 usable by a consumer with one or more aspects of the systems and methods described in further detail below. As shown in FIG. 1, the computer system 100 may include a central processing unit (CPU) 114 for executing computer-executable process steps and interfaces with a computer bus 116. Also shown in FIG. 1 are a network interface 118, a display device interface 120, a keyboard or input interface 122, a pointing device interface 124, an audio interface 126, a video interface 132, and a hard disk drive 134.

As described above, the disk 134 may store operating system program files, application program files, web browsers, and other files. Some of these files may be stored on the disk 134 using an installation program. For example, the CPU 114 may execute computer-executable process steps of an installation program so that the CPU 114 can properly execute the application program.

A random access main memory (“RAM”) 136 may also interface to the computer bus 116 to provide the CPU 114 with access to memory storage. When executing stored computer-executable process steps from the disk 134, the CPU 114 stores and executes the process steps out of the RAM 136.

Read only memory (“ROM”) 138 may be provided to store invariant instruction sequences such as start-up instruction sequences or basic input/output operating system (BIOS) sequences for operation of the keyboard 122.

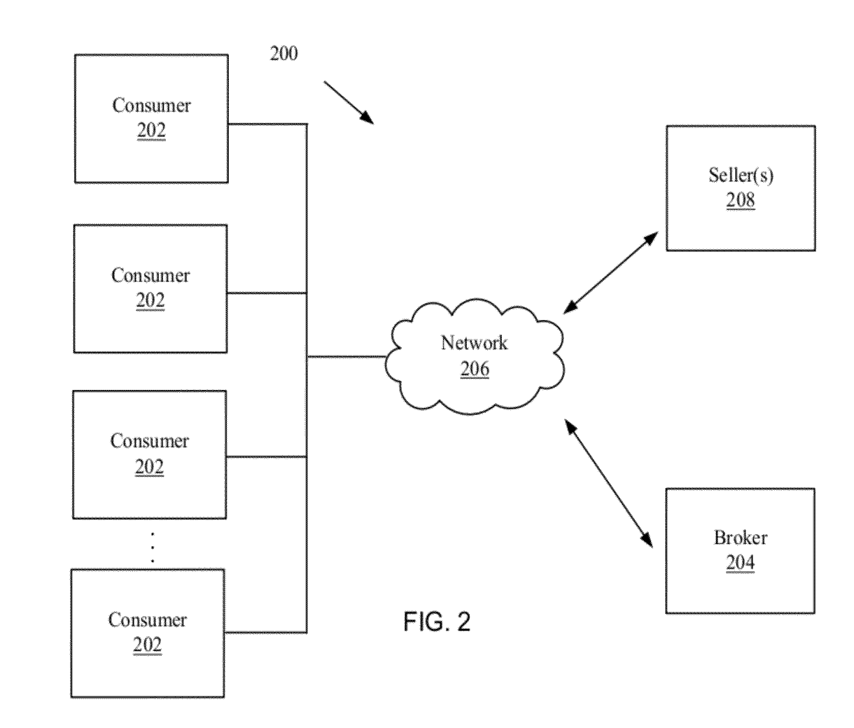

FIG. 2 is a block diagram illustrating a general overview of a group aggregation leveraging system 200 according to one aspect of the present invention. In the group aggregation leveraging system 200, a tiered pricing model may be used such that the cost of the products offered for sale decrease at set intervals where the intervals are determined by the number of products sold. In other words, by using a tiered pricing model, the cost of the product decreases after a predetermined number of products are sold within a specific predetermined time frame.

Consumers 202 may purchase products for a first fixed price from a broker 204. Although four (4) consumers are shown, this is by way of example only; the number of consumers can be unlimited. The consumers 202 may be coupled to a network 206, such as the Internet, through which they communicate with the broker 204 using a web browser stored in the memory of a computer system as described above. In one embodiment, the broker 204 may offer products on behalf of itself offering one or more products from inventory, while in other embodiments the broker may offer products on behalf of one or more sellers 208.

As described in more detail below, once a predetermined number of consumers commit to purchase the product during a predetermined time period, all committed consumers receive the product at a second fixed price wherein the second fixed price is less than the first fixed price. That is, as the number of consumers commit to purchasing the product, the fixed price decreases at set intervals. As a result, the consumers have an incentive to notify and encourage others to purchase the product so that the cost of the product is reduced. This process may be continued until the predetermined time period is over and/or the inventory of the product has been depleted.

In accordance with one embodiment, a consumer may be committed to the purchase by agreeing to the purchase and supplying credit card information to be charged upon a final determination of the price or by paying a deposit.

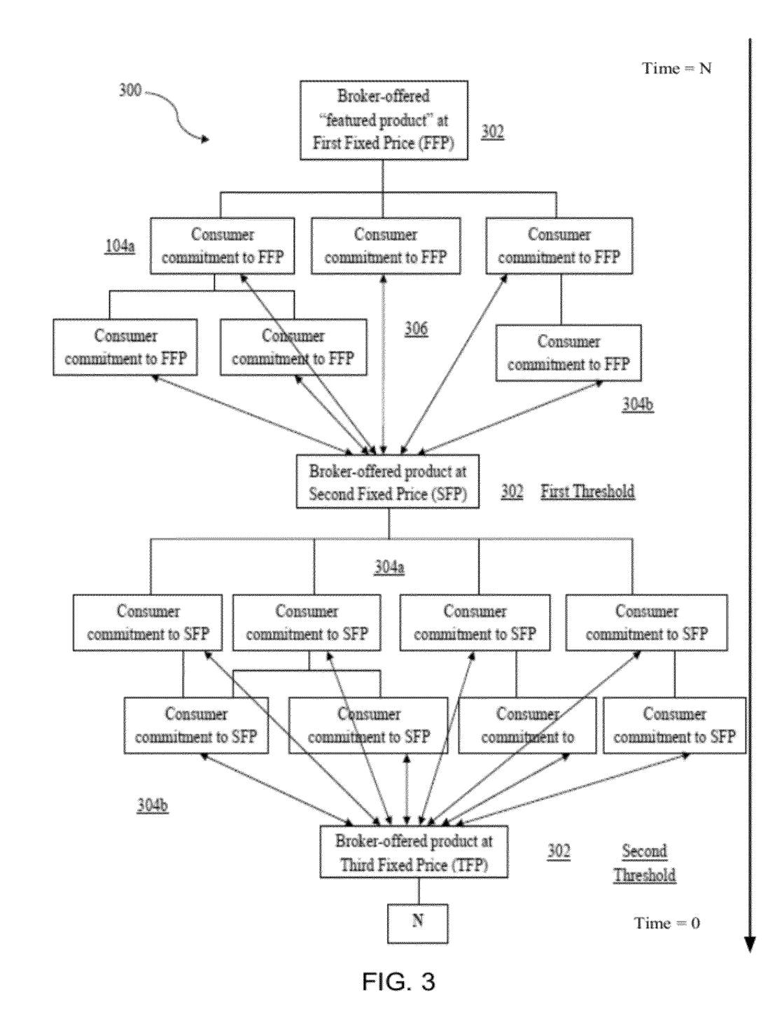

FIG. 3 illustrates a diagram of an e-commerce group aggregation leveraging system according to an embodiment of the invention. As shown in FIG. 3, the system 300 may begin with a broker 302 who offers one or more consumers 304a one or more products (“featured product”) at a first fixed price for a predetermined time period (i.e., Time equals N to Time equals 0, or, “time clock”). The first fixed price may be, e.g., a discounted price of a retail value price or a lowest advertised or published price. In some embodiments, the broker 302 may be a service provider offering one or more products from inventory, while in other embodiments; the broker 302 may be a broker who offers one or more products from a number of different or same sellers. The platform for the system is preferably an interactive website; however, other business platforms are within the scope of the invention (e.g., live auction or mobile-to-mobile applications).

According to embodiments of the invention, the system 300 may allow disparate and/or related consumers 304 to leverage their buying power by aggregating their numbers to receive discounts on the featured product. In some embodiments, consumers 304a may further leverage their buying power by communicating the sale of the featured product to other consumers 304b within their social network. The communication can take place via traditional or electronic means including, but not limited to, face to face contact, telephone, electronic mail, text messaging, instant messaging or postings on personal websites or social media websites such as Facebook®, MySpace® or Twitter® among many other social media websites known by one of ordinary skill in the art. If those additional consumers 304b commit to purchasing the featured product, the volume of consumers increases faster allowing more time to meet the next discount price threshold (or next tier in the tier pricing model) and potentially realizing more cost savings. At the same time, the broker 302 can deplete inventory faster and position itself to sell more products and/or expand its business, for example.

Continuing to refer to FIG. 3, once a predetermined number of consumers 304a and optionally consumers 304b have committed to purchasing the featured product at the first fixed price (FFP), the broker 302 may aggregate the consumer commitments to provide those consumers with a second fixed price (SFP) for the same featured product. Thus, the “first threshold” (or tier) is reached. The SFP is a discounted FFP and may alternatively or optionally include “upgrades” or “add-ons” to the featured product. Moreover, once the first threshold is reached, the broker 302 may communicate the new SFP to the committed consumers 304a and/or 304b via electronic means such as text messages, electronic mail (post-communication or post-alert) or any other method of communication as known by one of ordinary skill in the art. This process may be reiterated until the “second threshold” is reached with the featured product now offered at a third fixed price (TFP), and so on and so forth (Box “N”) until (i) the predetermined time period expires; or (ii) inventory of the product is depleted.

In some embodiments, the broker 302 may communicate to the committed consumers 304a via electronic means such as text messages or electronic mail before the first threshold is reached to inform those consumers 304a that a threshold is at the verge of being reached (pre-communication or pre-alert). In this manner, the consumers 304a may, again, further leverage their buying power by communicating the sale of the featured product to other consumers 304b within their social network and thereby incentivizing and potentially accelerating commitment(s) to purchase the featured product.

In one embodiment, the system 300 may include an added incentive for the consumer 304a, 304b to commit early to purchase the featured product before the featured product reaches the next tier or threshold. For example, each consumer 304a, 304b may be offered an “upgrade” or “add-on” to the featured product if that consumer 304a, 304b commits to purchase the featured product before the first threshold is met; each subsequent consumer 304a, 304b may be offered another “upgrade” or “add-on” to the featured product if that subsequent consumer 304a, 304b commits to purchase the featured product before the second threshold is met; and so on and so forth until (i) the predetermined time period expires; or (ii) inventory of the product is depleted. In some embodiments, the “upgrade” or “add-on” may be different and/or decrease in value as each threshold is met. In this respect, the consumers 304a, 304b have the incentive to commit to the featured product sooner rather than later.

At least one goal of the broker 302 may be to sell as much available inventory (featured product) as possible by incentivizing the sale of the featured product by performing and/or facilitating the following: (i) aggregating disparate and/or related consumer commitments to purchase in order to sell more of the featured product; (ii) providing a limited time for the consumer to make the commitment in order to influence the consumer to commit to the purchase sooner rather than later; and/or (iii) providing the committed consumer with instantaneous or substantially instantaneous “alerts” of a lower price once certain thresholds are met, or before a threshold is met, in order to influence the consumer to leverage their social network to add more potential consumers to pool of potential consumers. At least one goal of the consumers 304a, 304b is to get the lowest price possible for the featured product by: (i) committing to the purchase; and/or (ii) communicating the featured product to others within their social network thereby increasing the pool of potential consumers.

Once the time period expires, the transaction for the actual purchase of the featured product may be performed by an online transaction processing schema, or OLTP, as known by one of ordinary skill in the art or any equivalent transaction processing schema thereof. In some embodiments, a percentage of the completed sale of the featured product can be donated to the consumer's choice of sustainability efforts, e.g., fossil fuel alternatives, water conservation organizations, etc.

While the present invention is described primarily with respect to the travel industry, this is by way of example only and may be applied and adapted to various applications and industries. The system as described previously may be used in numerous industries including, but not limited to, the travel industry, the restaurant industry, the entertainment industry or any other service provider industry, or, alternatively, any consumer goods-providing industry.

In one embodiment, an interactive website provides a portal for the system used in, for example, the travel industry. The “featured product” may be, e.g., a travel package. Each week (or day or month) a unique travel package, or “travel deal,” may be offered via the website for a defined booking period. The travel deal may be open to the public or may be limited to those registered users of the website. In a particular example, the travel deal may be a two night hotel stay that includes a round of golf. For this particular travel package or deal, the pricing structure may be as follows:

TABLE 1

| | | Optional | |
|---|---|---|---|
| | Price | upgrade/add-on | Tier/Threshold |
| Published Rate | $400 | N/A | N/A |
| First 25 bookings | $350 | 2000 airline miles | First Fixed Price (FFP) |
| After 25 bookings | $300 | 1000 airline miles | Second Fixed Price (SFP); |
| | | | First Threshold/Tier |
| After 50 bookings | $250 | 500 airline miles | Third Fixed Price (TFP); |
| | | | Second Threshold/Tier |

The consumer may participate in committing to purchase the travel deal according to the system as described previously with respect to FIG. 3. Once a new threshold/tier/level has been reached, the system may automatically notify or alert each committed consumer (or, “traveler” according to this example) via Secured Messaging System (“SMS”) text, electronic mail notification or any other known method of communication depending on the consumer preference) that the price of the deal has dropped. According to this example, once the twenty-fifth (25^{th}) booking is processed, all twenty-five (25) consumers (i.e., travelers) are sent an SMS text that the price is now $300, and if twenty-five (25) more consumers book the same travel deal, the price will drop again to $250. In this manner, the travelers remain engaged throughout the booking period which empowers and/or incentivizes each consumer to continue sharing the deal within, e.g., his/her social network.

According to this embodiment, the system may include an added incentive for the consumer to commit early to purchase the travel deal before the travel deal reaches the next tier or threshold for as long as the travel deal remains “live”. In this example, airline miles may be the “add-on”; however, the system is not limited by this representative example. In this example, each consumer committing to purchase the travel deal before the first threshold is reached may receive 2000 airline miles in addition to the discounted price for the travel deal offered at this threshold. Next, each subsequent consumer committing to purchase the travel deal before the second threshold is reached may receive 1000 airline miles in addition to the discounted price for the travel deal offered at this threshold. Next, each subsequent consumer committing to purchase the travel deal before the third threshold is reached may receive 500 airline miles in addition to the discounted price for the travel deal offered at this threshold. In this respect, the consumers have the incentive to commit to the travel deal sooner rather than later (i.e., a so-called “Early-Bird Advantage”). Examples of other upgrades and add-ons include, but are not limited to, room upgrades, rental car certificates, local tours or any other suitable travel-industry related upgrade (in accordance with this example).

That is, if more than fifty (50) bookings are booked, consumers one (1) through twenty-five (25) will pay the third fixed price (TFP) in addition to acquiring the 2000 airline miles. Similarly, if more than fifty (50) bookings are booked, consumers twenty-six (26) through fifty (50) will pay the TFP in addition to acquiring the 1000 airline miles. In this manner, all committed consumers will receive the same discounted price when the time clock reaches zero while those who committed early rather than later will receive a greater value upgrade or add-on.

According to embodiments of the invention, an optional voting mechanism may be incorporated into the system. For example, using the above example in the travel industry, travelers may be given a preview of travel deals which may become available (“proposed travel deal”) in the following period and asked to vote on their favorite proposed travel deal(s). In one embodiment, voting is limited to affirmative action only in that the traveler either votes affirmatively on a proposed travel deal or abstains from voting. The interactive website may feature a user-driven web feature which allows the traveler to simply click in order to register his/her vote. The more votes a proposed travel deal receives, the higher its placement on the website homepage. In this manner, voting keeps the consumer engaged and helps them narrow down the best travel deals. For suppliers, deal voting provides a forecast for demand when the deal goes live for booking. Deal voting also turns consumers into negotiators. A supplier will want the highest ranking on the homepage, and to do so, will need their best possible price points and amenities to generate more votes.

According to embodiments of the invention, an optional collaboration mechanism may be incorporated into the system. For example, using the above example in the travel industry, once a deal closes, the system may give travelers the option of meeting their fellow travelers (in person or via electronic medium) who helped create the value (i.e., the discounted price). Travelers may or may not be traveling on the same dates, and yet, they bought the same product and are traveling to the same destination. This creates an opportunity to receive quality travel advice and the ability to forge new friendships. For example, a traveler could ask “Should I rent a car.” Another traveler can respond and say “It's not worth it. Take a taxi and you'll save a ton of money.” Or a traveler can say “I'm traveling March 23-25th and plan on going to Club Tryst at the Wynn.” Another traveler can respond “Great idea, my friends and I will be there also . . . the first round is on us!” In this manner, the system incorporates social, cultural, and educational experiences of the consumers.

In some embodiments, the system may optionally include a portal to upload a user profile. The user profile may optionally include, for example, a “wishlist.” Current and potential consumers may have the option to upload proposed products (i.e., travel trips) onto their wishlist. The broker may use that data to help determine the types of trips the system will feature on the system website. In some embodiments, the system website may optionally offer and/or include user-participant contests, e.g., a “trip idea contest.” Users (or consumers) may submit creative trip ideas via the system website. Once the trip ideas are narrowed down, the user community may vote on their favorite trip ideas via the system website at the broker/supplier's discretion. For example, a trip idea may be, “I want to go mountain climbing in Peru and stay at a four-star hotel.” Users may vote for the trip idea which is then subsequently featured on the system website. In one example, the “winner” is the trip idea which receives the highest sales volume or most bookings and the user who submitted the trip idea travels for free on this particular trip.

Advantages of the system include the opportunity for discounted pricing on featured product(s) other than what the buyer can achieve on his/her own. Also, the buyer does the marketing of the featured product(s) for the broker and/or supplier as the consumers have incentive to share the offer in their social networks. The result is the building of valuable group/volume business for suppliers. Moreover, the real-time notifications of price drops keeps buyers active in the buyer commitment process and substantially in control of the final price. Additionally, system notifications encourages that consumers will continue to market the offer for the featured product aggressively.

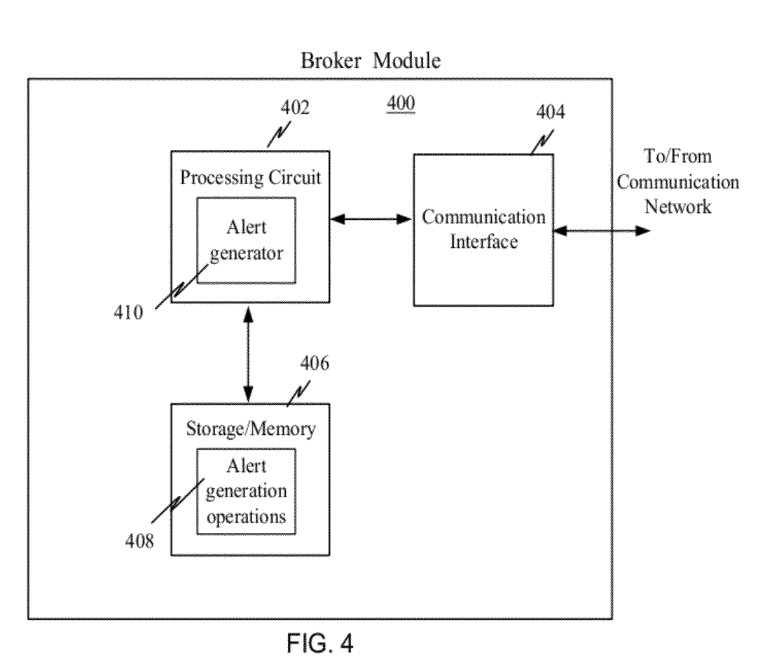

FIG. 4 is a block diagram illustrating an example of a broker module 400 configured to offer limited time deals having real-time tiered pricing thresholds on products to consumers. The broker module 400 may include a processing circuit 402 (e.g., processor, processing module, etc.) coupled to a communication interface 404 to communicate with a network, such as the Internet, and a memory device 406 to locally store information related to deals, products, consumers and sellers. The memory/storage device 406 may include operations (instructions) for the tiered pricing model and for generating an alert 408. The processing circuit 402 may implement these operations and/or include an alert generator 410 that implements these operations.

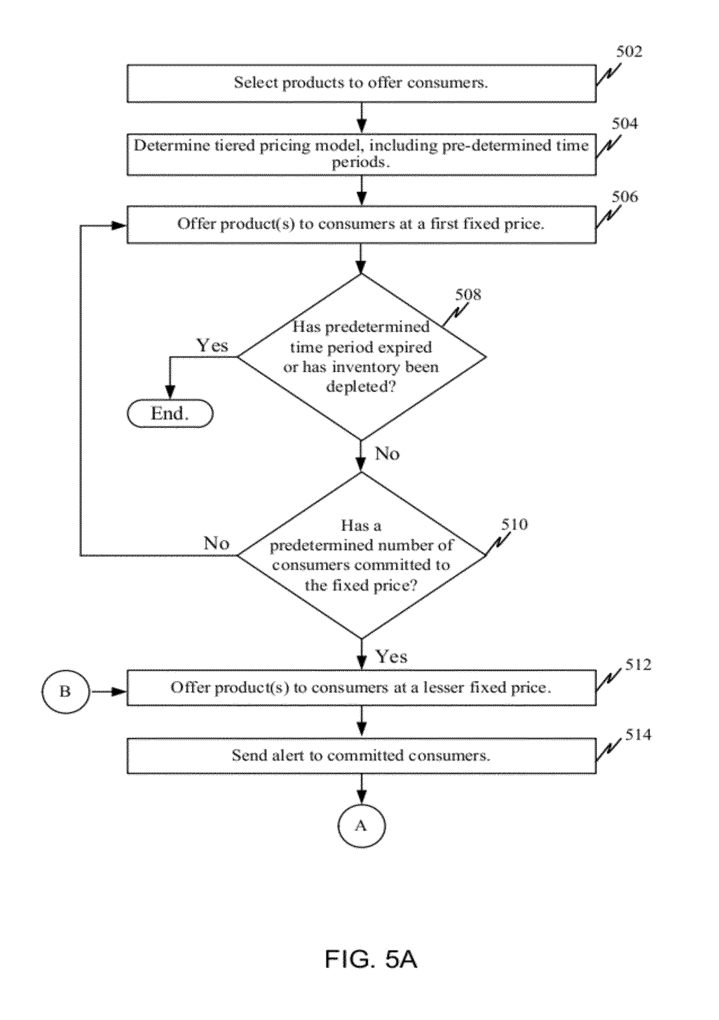

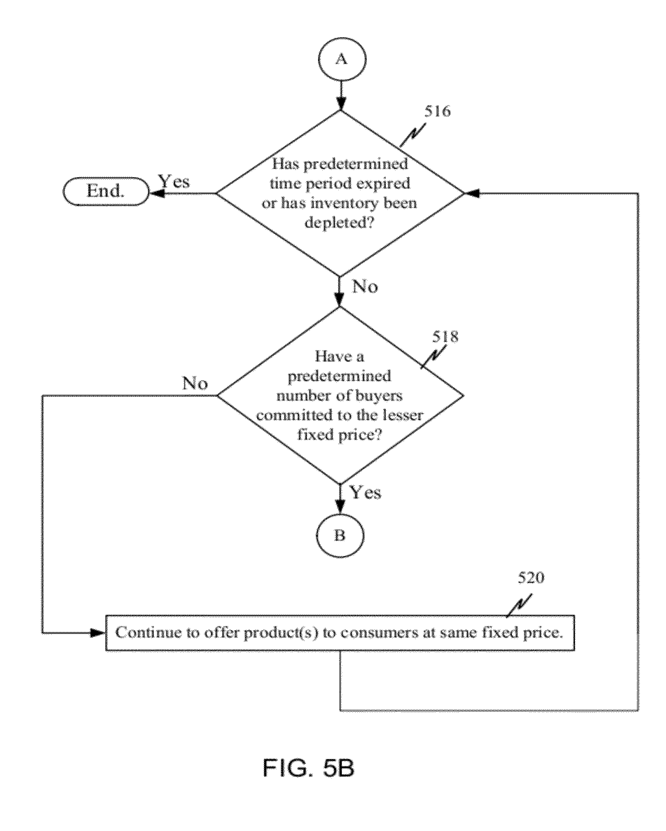

FIG. 5 (comprising FIGS. 5A and 5B) is a flow diagram illustrating a method operational in a broker module for offering limited time deals having real-time tiered pricing thresholds on products to consumers. First, a broker may select products or a featured product to offer for sale to consumers 502. As described above, the broker may be a service provider offering one or more products from inventory, while in other embodiments the broker may offer one or more products from a number of different or same sellers.

Once the products have been selected, the broker may determine the tiered pricing model to be offered to the consumers 504. That is, the broker determines progressively decreasing price points of the product and the intervals which the price decreases. For example, in one embodiment, a product may be offered at a first fixed rate of $900 and if 30 consumers commit to purchase the product, the price decreases to a second fixed rate of $800 and if 50 consumers commit to purchase the product the price decreases to a third fixed rate of $700. As the price of the product decreases when a predetermined number of consumers commit to purchase the product, there is an incentive for all consumers to encourage others to also purchase the product. In other words, the consumer can leverage their buying power by aggregating disparate and/or related consumer commitments to purchase the product.

Next, the products may be offered to consumers for a first fixed price for a predetermined time period 506. Once the predetermined time period has expired and/or the inventory has been depleted 508, the product is no longer offered for sale by the broker. Alternatively, if the predetermined time period has not expired and/or the inventory has not been depleted 508, a determination is made as to whether a predetermined number of consumers have committed to purchase the product 510. If the predetermined number of consumers committing to the purchase has not been met, the product is continued to be offered at the first fixed price. Alternatively, if the predetermined number of consumers committing to the purchase has been met 510, the product is offered to consumers at a lesser fixed price 512. That is, the next offer price is less than the first fixed price and is the next tier/level in the tiered pricing model. Once the next tier/level has been reached, an alert may be sent to all consumers that have already committed to purchase the product 514. The alert may be used to notify all committed consumers that the next level/tier/threshold in the tiered pricing has been met and the price of the product has been reduced. The alert may be in the form of a text message, an email or any other form of communication known in the art.

Next, a determination may again be made as to whether the predetermined time period has expired and/or the inventory has been depleted 516. If the predetermined time period has expired and/or the inventory has been depleted, the product is no longer offered for sale by the broker. Alternatively, if the predetermined time period has not expired and/or the inventory has not been depleted 516, a determination is made as to whether a predetermined number of consumers have committed to purchase the product 518. If the predetermined number of consumers committing to the purchase has not been met, the product is continued to be offered at the same fixed price 520. Alternatively, if the predetermined number of consumers committing to the purchase has been met 518, the product is offered to consumers at an even lesser fixed price 512. The lesser fixed price is the next level/tier/threshold in the tiered pricing model. Once the next level/tier/threshold has been reached, an alert may be sent to all consumers that have already committed to purchase the product 514. This process is continued until the predetermined time period has expired and/or the inventory of the product has been depleted.

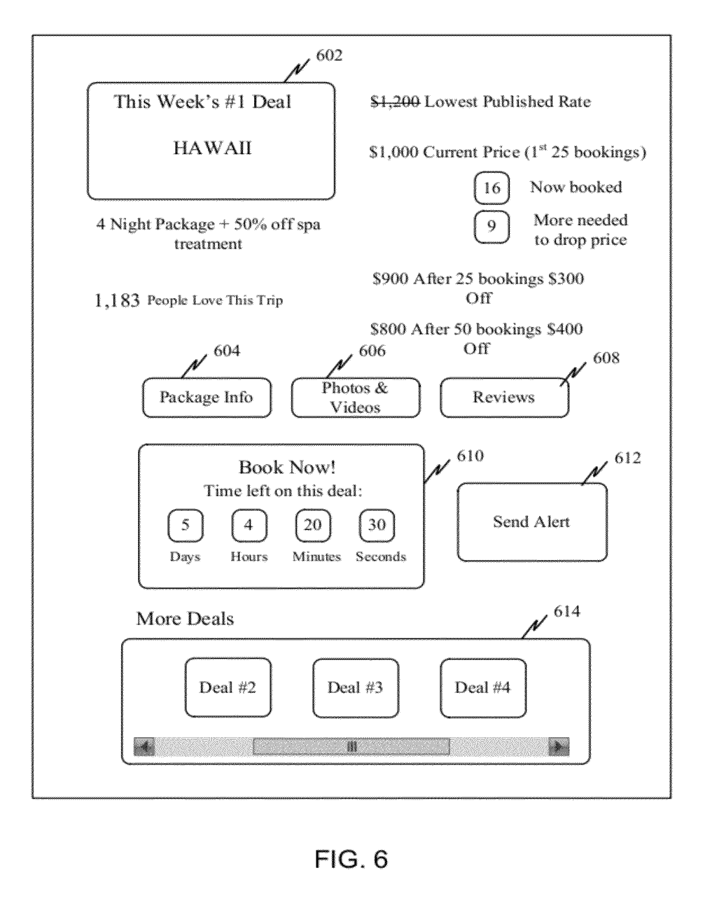

FIG. 6 illustrates an example of a screen on a website-based e-commerce site for facilitating the aggregation of unrelated consumer purchase commitments for a featured product using real-time tiered pricing thresholds. As shown in FIG. 6, the broker may offer a main deal or featured product 602 for sale to consumers. The main deal, for example, may be a trip to Hawaii for four (4) nights and includes 50% off a spa treatment. The tiered pricing threshold may be displayed on the screen. For example, lowest published rate may be $1,200, but the web-site is offering a first fixed price of $1,000. Sixteen (16) consumers are now booked or committed to purchasing the trip to Hawaii and nine (9) more consumers are needed to drop the price to the second fixed price of $900, which is $300 off the lowest published rate. After fifty (50) consumers have committed, the second fixed price is reduced to the third fixed price of $800 which is $400 off the lowest published rate.

All potential consumers to the website can find out more information about the deal and the trip by selecting a “package info” button 604, a “photos and videos” button 606 or a “reviews” button 608. The potential consumer may also view a timer 610 on the website to determine how much time is left on the current deal or featured product. Additionally, the consumer may send an alert 612 to others, such as family, friends and co-workers, notifying them of the deal and encouraging them to commit to purchasing eth product in order to decrease the cost and increase the savings. The website may offer additional deals 614 for consumers to choose from.

A storage medium may represent one or more devices for storing data, including read-only memory (ROM), random access memory (RAM), magnetic disk storage mediums, optical storage mediums, flash memory devices and/or other machine readable mediums for storing information. The terms “machine readable medium” and “computer readable medium” include, but are not limited to portable or fixed storage devices, optical storage devices, and/or various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated in the figures may be rearranged and/or combined into a single component or embodied in several components without departing from the invention. Additional elements or components may also be added without departing from the invention. Additionally, the features described herein may be implemented in software, hardware, as a business method, and/or combination thereof.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

What is claimed is:

1. A method for facilitating the aggregation of unrelated consumer purchase commitments for a product using real-time tiered pricing thresholds, comprising:
offering the product to consumers for a first fixed price for a predetermined time period; and
offering the product to the consumers for a second fixed price after a first predetermined number of consumers commit to purchase the product at the first fixed price and the predetermined time period has not expired, the second fixed price is less than the first fixed price.

2. The method of claim 1, further comprising:
sending an alert to each committed consumer that a cost of the product has decreased from the first fixed price to the second fixed price after receiving the first predetermined number of consumer commitments to purchase the product at the first fixed price.

3. The method of claim 1, further comprising:
offering the product to the consumers for a third fixed price after a second predetermined number of consumers commit to purchase the product at the second fixed price and the predetermined time period has not expired, the third fixed price is less than the second fixed price.

4. The method of claim 3, further comprising:
sending an alert to each committed consumer that a cost of the product has decreased from the second fixed price to the third fixed price after receiving the second predetermined number of consumer commitments to purchase the product at the second fixed price.

5. The method of claim 1, wherein the first predetermined number of consumers comprises a first threshold and the second predetermined number of consumers comprises a second threshold.

6. The method of claim 1, wherein a cost of the product continually decreases at predetermined intervals until the predetermined time period has expired.

7. The method of claim 1, wherein a cost of the product continually decreases at predetermined intervals until inventory of the product has been depleted.

8. The method of claim 5, further comprising:
offering an added incentive to the consumers to commit purchasing the product prior to reaching a new threshold in the tiered pricing thresholds.

9. The method of claim 1, wherein the consumers leverage buying power by notifying potential consumers of the product for sale to increase and accelerate committed consumers.

10. A broker module for facilitating the aggregation of unrelated consumer purchase commitments for a featured product using real-time tiered pricing thresholds, comprising:
a memory device;
a network interface for communicating over a wireless network;
a processing circuit coupled between the memory device and the network interface and adapted to
offer the product to consumers for a first fixed price for a predetermined time period; and
offer the product to the consumers for a second fixed price after a first predetermined number of consumers commit to purchase the product at the first fixed price and the predetermined time period has not expired, the second fixed price is less than the first fixed price.

11. The broker module of claim 10, wherein the processing circuit is further adapted to
send an alert to each committed consumer that a cost of the product has decreased from the first fixed price to the second fixed price after receiving the first predetermined number of consumer commitments to purchase the product at the first fixed price.

12. The broker module of claim 10, wherein the processing circuit is further adapted to
offer the product to the consumers for a third fixed price after a second predetermined number of consumers commit to purchase the product at the second fixed price and the predetermined time period has not expired, the third fixed price is less than the second fixed price.

13. The broker module of claim 12, wherein the processing circuit is further adapted to
send an alert to each committed consumer that a cost of the product has decreased from the second fixed price to the third fixed price after receiving the second predetermined number of consumer commitments to purchase the product at the second fixed price.

14. The broker module of claim 10, wherein the first predetermined number of consumers comprises a first threshold and the second predetermined number of consumers comprises a second threshold.

15. The broker module of claim 10, wherein a cost of the product continually decreases at predetermined intervals until the predetermined time period has expired.

16. The broker module of claim 10, wherein a cost of the product continually decreases at predetermined intervals until inventory of the product has been depleted.

17. The broker module of claim 14, wherein the processing circuit is further adapted to
offer an added incentive to the consumers to commit purchasing the product prior to reaching a new threshold in the tiered pricing thresholds.

18. A computer readable medium having one or more instructions operational on a broker module for facilitating the aggregation of unrelated consumer purchase commitments for a featured product using real-time tiered pricing thresholds, which when executed by a processor causes the processor to:
offer the product to consumers for a first fixed price for a predetermined time period; and
offer the product to the consumers for a second fixed price after a first predetermined number of consumers commit to purchase the product at the first fixed price and the predetermined time period has not expired, the second fixed price is less than the first fixed price.

19. The computer readable medium of claim 18 having one or more instructions which when executed by a processor causes the processor to further:
send an alert to each committed consumer that a cost of the product has decreased from the first fixed price to the second fixed price after receiving the first predetermined number of consumer commitments to purchase the product at the first fixed price.

20. The computer readable medium of claim 18 having one or more instructions which when executed by a processor causes the processor to further:
offer the product to the consumers for a third fixed price after a second predetermined number of consumers commit to purchase the product at the second fixed price and the predetermined time period has not expired, the third fixed price is less than the second fixed price.
